(19) United States
(12) Patent Application Publication
(10) Pub. No.: US 2024/0313247 A1
(43) Pub. Date: Sep. 19, 2024

(54) Metal Supported Proton Conduction Fuel Cell with Structured Electrolyte

(71) Applicant: Nissan North America, Inc., Franklin, TN (US)

(72) Inventors: Cenk Gumeci, Northville, MI (US); Sandeep Patil, Farmington Hills, MI (US)

(21) Appl. No.: 18/183,321

(22) Filed: Mar. 14, 2023

(51) Int. Cl. H01M 8/1016; H01M 4/86; H01M 4/90; H01M 8/0232; H01M 8/0258; H01M 8/1007

(52) U.S. Cl. CPC H01M 8/1016; H01M 4/8652; H01M 4/9016; H01M 8/0232; H01M 8/0258; H01M 8/1007; H01M 2004/8684; H01M 2300/0071

(57) ABSTRACT

A proton conduction fuel cell has an anode support made of metal having a fuel flow channel, an anode comprising an anode active material in contact with the anode support, a cathode support made of metal having a cathode gas flow channel, a cathode comprising a cathode active material in contact with the cathode support, and an electrolyte layer. The electrolyte layer comprises a first layer of electrolyte formed in a lock pattern on the anode and a second layer of the electrolyte formed in a key pattern on the cathode. The second layer fits in the lock pattern of the first layer to form the electrolyte layer.

### TECHNICAL FIELD

This disclosure relates to a metal supported proton conduction fuel cell having a lock and key structured electrolyte.

### BACKGROUND

Proton conduction fuel cells (PCFCs), also known as protonic ceramic fuel cells, are being investigated for larger-scale applications, such as vehicles, large stationary fuel cell units and aerial applications. However, PCFCs are not easily adaptable to these larger-scale applications as they lack durability, require time to come up to operating temperature, are complex to manufacture and are manufactured from expensive materials.

Addressing the drawbacks to PCFCs in larger-scale applications is an objective of the implementations disclosed herein.

### SUMMARY

Disclosed herein are implementations of PCFCs having metal electrode supports and modifications to one or more of the electrolyte structure, anode structure and cathode structure to improve the bonding between layers and increase the PCFC's durability.

In one implementation, a PCFC has an anode support made of metal having a fuel flow channel, an anode comprising an anode active material in contact with the anode support, a cathode support made of metal having a cathode gas flow channel, a cathode comprising a cathode active material in contact with the cathode support, and an electrolyte layer. The electrolyte layer comprises a first layer of electrolyte formed in a lock pattern on the anode and a second layer of the electrolyte formed in a key pattern on the cathode. The second layer fits in the lock pattern of the first layer to form the electrolyte layer.

In another implementation, a PCFC has an anode support made of metal, an anode comprising an anode active material in contact with the anode support, a cathode support made of metal, a cathode comprising a cathode active material in contact with the cathode support, and an electrolyte layer. The electrolyte layer comprises a first layer of electrolyte formed in a lock pattern on the anode and a second layer of the electrolyte formed in a key pattern and attached to the cathode with an adhesive, the second layer fitting in the lock pattern of the first layer to form the electrolyte layer.

In another implementation, a PCFC has an anode support made of metal, an anode comprising an anode active material in contact with the anode support, a cathode support made of metal, a cathode comprising a cathode active material in contact with the cathode support, and an electrolyte layer. The anode support has an anode facing surface having surface irregularities in a form of a lock pattern. A support facing surface of the anode is modified to have a key pattern, the key pattern of the support facing surface fitting in the lock pattern of the anode facing surface of the anode support.

In another implementation, a PCFC has an anode support made of metal, an anode comprising an anode active material in contact with the anode support, a cathode support made of metal, a cathode comprising a cathode active material in contact with the cathode support, and an electrolyte layer. The cathode has a smaller surface area perpendicular to a stacking direction than the cathode support and the electrolyte layer, defining a perimeter space around the cathode. The proton conduction fuel cell further comprises adhesive in the perimeter space.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a side view schematic showing the layers of an implementation of a PCFC as disclosed herein.

FIG. 2A is a plan view of an anode and a first layer of electrolyte of the PCFC shown in FIG. 1.

FIG. 2B is a plan view of a cathode and a second layer of electrolyte of the PCFC shown in FIG. 1.

FIG. 3A is a side view of FIG. 2A.

FIG. 3B is a side view of FIG. 2B.

FIG. 4A is a plan view of the anode and another aspect of the first layer of electrolyte of the PCFC shown in FIG. 1.

FIG. 4B is a plan view of the cathode and another aspect of the second layer of electrolyte of the PCFC shown in FIG. 1.

FIG. 5 is a side view schematic showing the layers of another implementation of a PCFC as disclosed herein.

FIG. 6 is an enlarged view of the cathode support and cathode of the PCFC shown in FIG. 5.

FIG. 7 is a side view schematic showing the layers of another aspect of the PCFC shown in FIG. 5 as disclosed herein.

FIG. 8A is a schematic of an example of a unit of multiple PCFCs.

FIG. 8B is an enlarged portion of FIG. 8A illustrating countercurrent fuel/cathode gas flow.

### DETAILED DESCRIPTION

PCFCs have a ceramic, solid electrolyte material that conducts protons from the anode to the cathode. PCFCs produce electricity by removing an electron from a hydrogen atom, moving the charged hydrogen atom through the ceramic electrolyte, and returning the electron to the hydrogen on the other side of the electrolyte during a reaction with oxygen. Proton conductivity through the electrolyte can be achieved at temperatures ranging from about 200° C. to about 600° C., which is lower than solid oxide fuel cells, which typically operate at temperatures above 600° C. The ability to operate at intermediate and high temperatures enables the use of a variety of liquid hydrogen carrier fuels such as methane in addition to hydrogen gas.

The use of PCFCs in larger-scale applications, such as vehicles or stationary stations, is challenging for many reasons. Conventional PCFCs use an anode support layer that includes about 20 wt. % starch mixed with the anode active material. The anode support layer must be quite thick to provide adequate support for the cell, upwards of 500 μm. The anode layer is formed on this anode support layer. Conventional PCFCs are not particularly durable due in part to this anode support layer. The use of the anode support layer also lengthens the time needed to start up the cell, requiring extended time periods to bring the anode support layer up to operating temperature. Conventional PCFCs can be complex to manufacture, and materials, such as the cathode material, can be costly.

The PCFCs disclosed herein address these issues by replacing the traditional anode support layer with a metal support and incorporating a metal support for the cathode. The metal supports are hollow, allowing for fluid flow within the hollowed metal support structures. The metal support structures allow for operating temperatures to be quickly reached, reducing the time necessary for start-up. The metal support structures also increase durability of the individual cells and multi-cell systems. The metal supports also allow for manufacture of large scale units with multiple cells.

Use of the metal support structures to support the anode and the cathode in PCFCs changes the method of manufacture, and can introduce problems with compatibility between the materials used for the cathode, anode and electrolyte. The structures disclosed herein provides means of providing cathode, electrolyte and anode layers that promote interfacial contact and adhesion between the layers.

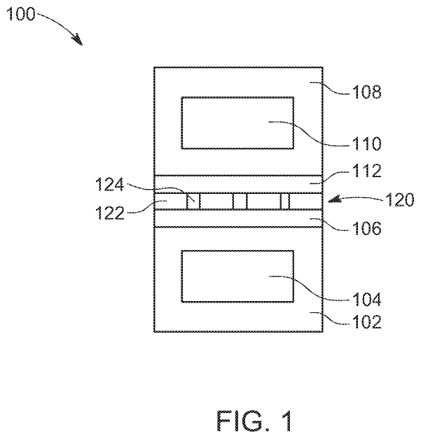

FIG. 1 is a side view schematic of a PCFC 100 as disclosed herein. The PCFC 100 has an anode support 102 made of metal. The metal is porous, allowing for fuel to flow. Examples of fuel include, but are not limited to hydrogen and methane. Optionally, the anode support 102 may include a fuel flow channel 104 to ensure adequate flow of fuel to the PCFC 100. The fuel flow channel 104 is illustrated as a single channel, but may be multiple channels. The anode support 102 provides strength and durability to the PCFC 100, so the fuel flow channel 104, whether a single channel or multiple channels, is formed while maintaining walls of the anode support 102 with adequate strength. The metal is stainless steel, and preferably austenitic stainless steel, having at least 16% chromium and 6% nickel. The anode support 102 can range from 50 μm to 200 μm in thickness.

An anode 106 comprising an anode active material is in contact with the anode support 102. The anode active material is a composite material of 40% to 50% BaCe_{0.4}Zr_{0.4}Y_{0.1}Yb_{0.1}O_{3-δ} and 60% to 50% nickel oxide (NiO). The anode 106 is formed on the anode support 102.

A cathode support 108 is made of metal. The metal is porous, allowing for cathode gas such as air or another oxidant to flow. Optionally, the cathode support 108 may include a cathode gas flow channel 110 to ensure adequate flow of oxygen to and/or improve the efficiency of the PCFC 100. The cathode gas flow channel 110 is illustrated as a single channel, but may be multiple channels. The cathode support 108 provides strength and durability to the PCFC 100, so the cathode gas flow channel 110, whether a single channel or multiple channels, is formed while maintaining walls of the cathode support 108 with adequate strength. The metal is stainless steel, and preferably austenitic stainless steel, having at least 16% chromium and 6% nickel. The cathode support 108 can range from 50 μm to 200 μm in thickness.

A cathode 112 comprising a cathode active material is in contact with the cathode support 108. The cathode active material can be one of BaCo_{0.4}Fe_{0.4}Zr_{0.1}Y_{0.1}O_{3-δ} (BCFZY), La_{0.6}Sr_{0.4}Co_{0.2}Fe_{0.8}O_{3-δ}(LSCF) or Sr₂Sc_{0.1}Nb_{0.1}Co_{1.5}Fe_{0.3}O_{6-δ}. The cathode active material can be a combination of BaCo_{0.4}Fe_{0.4}Zr_{0.1}Y_{0.1}O₃ and BaZr_{0.4}Ce_{0.4}Y_{0.1}Yb_{0.1}O₃. The cathode active material can be a 50%-50% composite of BCFZY and PrBa_{0.5}Sr_{0.5}Co_{1.5}Fe_{0.5}O_{5+δ} (PBSCF). The cathode active material is limited by the use of the metal cathode support 108. For example, La_{0.6}Sr_{0.4}Co_{0.2} (LSC), is a cathode active material that may work well with the conventional cell without metal, such as those using no cathode support or a ceramic cathode support and an anode support comprising starch. However, it is not sufficiently compatible with metal to use in the disclosed cells.

The PCFC 100 also has an electrolyte layer 120. The electrolyte used in the electrolyte layer 120 can have adhesion problems with the cathode active material. The PCFCs disclosed herein provide a modified electrolyte layer 120 to ensure adhesion between the electrolyte and the cathode active material, resulting in improved performance and durability. The electrolyte used in the electrolyte layer 120 can comprise one of BaCe_{0.4}Zr_{0.4}Y_{0.1}Yb_{0.1}O_{3-δ} or BaZr_{0.7}Ce_{0.2}Y_{0.1}O_{3-δ}. The electrolyte can be BaCe_{0.4}Zr_{0.4}Y_{0.1}Yb_{0.1}O_{3-δ} alone or BaCe_{0.4}Zr_{0.4}Y_{0.1}Yb_{0.1}O_{3-δ} with less than 3.0% NiO. The electrolyte can be BaZr_{0.7}Ce_{0.2}Y_{0.1}O_{3-δ} with less than 3.0% NiO. The electrolyte can also be one or more of BaZr_{0.8}Y_{0.2}O_{3-δ}, BaZr_{0.9}Y_{0.1}O₃, BaCe_{0.9}Gd_{0.1}O₃, BaCe_{0.8}Zr_{0.1}Gd_{0.1}O₃, and BaCe_{0.65}Zr_{0.2}Y_{0.15}O_{3-δ}. Because the composition of the electrolyte is similar to that of the anode active material, compatibility is generally not an issue.

The electrolyte layer 120 comprises a first layer 122 of electrolyte formed in a lock pattern on the anode 106 and a second layer 124 of the electrolyte formed in a key pattern on the cathode 112. The second layer 124 fits in the lock pattern of the first layer 122 to form the electrolyte layer 120. As used herein, a lock and key pattern is generic for an interlocking geometric motif that allows the key motif to pass into the lock motif.

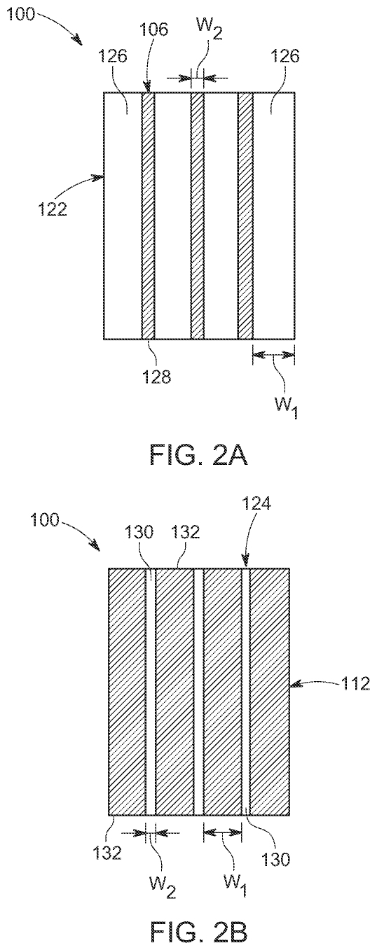

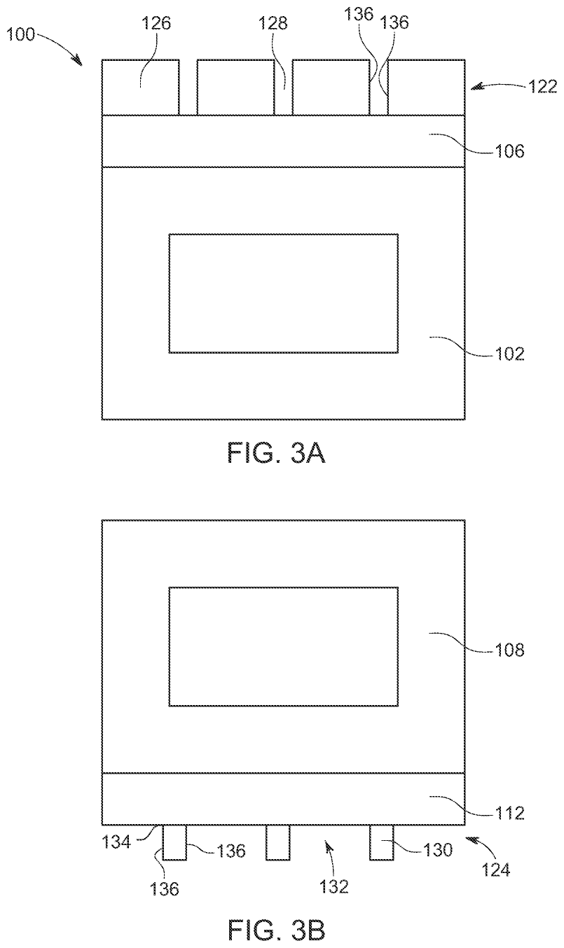

FIGS. 2A and 2B illustrate the first layer 122 and the second layer 124 in plan views, respectively, to illustrate a lock and key pattern as disclosed herein. FIGS. 3A and 3B illustrate FIGS. 2A and 2B, respectively, in a side view. FIG. 2A illustrates the first layer 122 of the electrolyte layer 120 in white, with the lock pattern of the first layer 122 being parallel first rows 126, each first row 126 having a first width W₁ with a first space 128 between adjacent first rows 126, the first space 128 having a second width W₂. In FIG. 2A, each first space 128 reveals the anode 106 on which the first layer 122 is formed.

FIG. 2B illustrates the second layer 124 of the electrolyte layer 120 in white, with the key pattern of the second layer 124 being parallel second rows 130, each second row 130 being the second width W₂ with a second space 132 between adjacent second rows 130, the second space 130 having the first width W₁. In FIG. 2B, each second space 132 reveals the cathode 112 on which the second layer 124 is formed. Put a different way, the second rows 130 are positioned on the cathode 112 to align with a respective first space 128 of the first layer 122.

To improve the adhesion between the electrolyte of the second layer 124 and the cathode 112, an adhesive is used between the second layer 124 and the cathode. The adhesive is used at the interface 134 between the cathode 112 and each second row 130, the interface 134 shown in FIG. 3B. Adhesive can also be used at the interface 136 between the electrolyte of the first layer 122 and the electrolyte of the second layer 124. The interface 136 is shown in FIGS. 3A and 3B and is found between side walls of the first rows 126 and the second rows 130.

Because the adhesive is an added material that may impact resistance and performance of the cell, the amount of adhesive used between the second layer 124 and the cathode 112 is minimized. To minimize the amount of adhesive, the first width W1 of the first rows 126 is greater than the second width W2 of the second rows 130.

The adhesive can be silicate glass, as one example. The silicate glass as adhesive can be used in particular with cathode active material that is one of BCFZY, LSCF, and Sr₂Sc_{0.1}Nb_{0.1}Co_{1.5}Fe_{0.3}O_{6-δ}. When the cathode active material is a combination of BaCo_{0.4}Fe_{0.4}Zr_{0.1}Y_{0.1}O₃ , and BaZr_{0.4}Ce_{0.4}Y_{0.1}Yb_{0.1}O₃, the adhesive can be a combination of silicate glass and BaCe_{0.4}Zr_{0.4}Y_{0.1}Yb_{0.1}O_{3-δ}, as an example. When the cathode active material of a 50%-50% composite of BCFZY and PBSCF, the adhesive can be a gasket material capable of sealing in extremely high temperatures, such as Thermiculite® 866 and 866 LS.

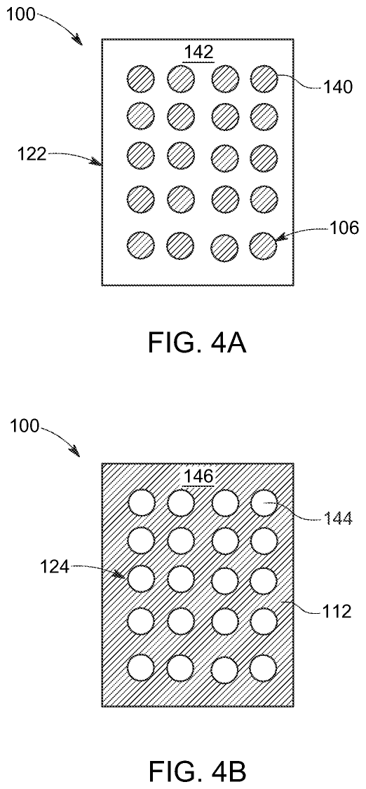

FIGS. 4A and 4B illustrate another implementation of the first layer 122 and the second layer 124 in plan views, respectively, of the electrolyte layer 120 to illustrate another lock and key pattern as disclosed herein. FIG. 4A illustrates the first layer 122 of the electrolyte layer 120 in white, with the lock pattern of the first layer 122 being cutouts 140 uniformly spaced across a surface area 142 of the first layer 122. In FIG. 4A, each cutout 140 reveals the anode 106 on which the first layer 122 is formed.

FIG. 4B illustrates the second layer 124 of the electrolyte layer 120 in white, with the key pattern of the second layer 124 being islands 144 of electrolyte each formed in the shape of the cutout 140 and uniformly positioned across a surface area 146 of the second layer 124 to align with the cutouts 140 of the first layer 122. In FIG. 4B, the cathode 112 shown in black diagonal lines illustrates the amount of surface area of the cathode 112 that is not covered by the electrolyte of the islands 144. Put a different way, the islands 144 of the second layer 124 are positioned on the cathode 112 to align with a respective cutout 140 of the first layer 122.

To improve the adhesion between the electrolyte of the second layer 124 and the cathode 112, an adhesive is used between the second layer 124 and the cathode. The adhesive is used at the interface between the cathode 112 and each island 144. Adhesive can also be used at the interface between the electrolyte of the first layer 122 and the electrolyte of the second layer 124. The interface is found between side walls of the cutouts 140 and the islands 144.

Because the adhesive is an added material that may impact resistance and performance of the cell, the amount of adhesive used between the second layer 124 and the cathode 112 is minimized. To minimize the amount of adhesive, a total surface area of the electrolyte in the first layer 122 is greater than a total surface area of the electrolyte in the second layer 124. For clarity, the total surface area of the electrolyte in the first layer 122 is the length times the width of the first layer 122 less the surface area of the cutouts 140, and the total surface area of the electrolyte in the second layer 124 is the total of the surface area of all islands 144.

The lock and key patterns described with respect to FIGS. 2A-4B are provided as examples and are not meant to be limiting. Other lock and key patterns can be used as contemplated by those skilled in the art.

Also disclosed herein are PCFCs with implementations that improve the adhesion between the anode 106 and the anode support 102 and the cathode 112 and the cathode support 108. These implementations can be used alone or in any combination with each other and with the electrolyte layer 120 implementations disclosed herein.

In one implementation of a PCFC 200 as disclosed herein, the anode support 202 has an anode facing surface 204 facing the anode 206 and the cathode support 208 has a cathode facing surface 210 facing the cathode 212. One or both of the anode facing surface 204 and the cathode facing surface 210 have surface irregularities. These surface irregularities 214, illustrated in FIG. 6 on the cathode facing surface 210 of the cathode support 208, can be formed, for example, by etching the metal surface. Other means of forming the irregularities 214 as known to those skilled in the art can be used, such as sanding, sand blasting, ablation, cutting, etc.

In one aspect of the PCFC 200, the cathode facing surface 210 has surface irregularities 214 as shown in FIG. 6. The cathode 212 has a smaller surface area A perpendicular to a stacking direction D than the surface area B of cathode support 208 or the electrolyte layer 220, defining a perimeter space 216 around the cathode 212. This perimeter space 216 is filled with adhesive 218, or a combination of adhesive and electrolyte, to improve adhesion and prevent leakage.

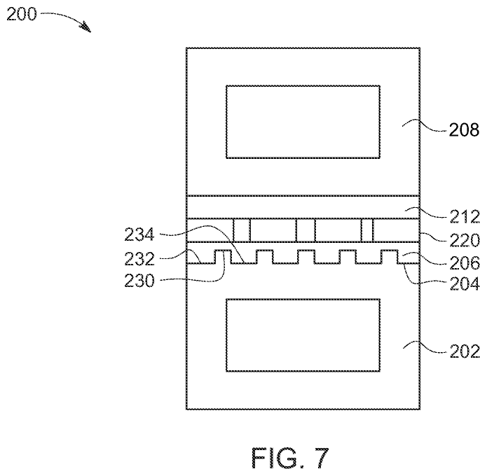

In another aspect of PCFC 200, shown in FIG. 7, the anode facing surface 204 of the anode support 202 has surface irregularities in a form of a lock pattern 230 and a support facing surface 232 of the anode 206 is modified to have a key pattern 234, the key pattern 234 of the support facing surface 232 of the anode 206 fitting in the lock pattern 230 of the anode facing surface 204 of the anode support 202. The lock pattern 230 and the key pattern 234 are provided as an example, and may have other lock and key structures as contemplated by those skilled in the art. No adhesive is necessary between the anode support and the anode.

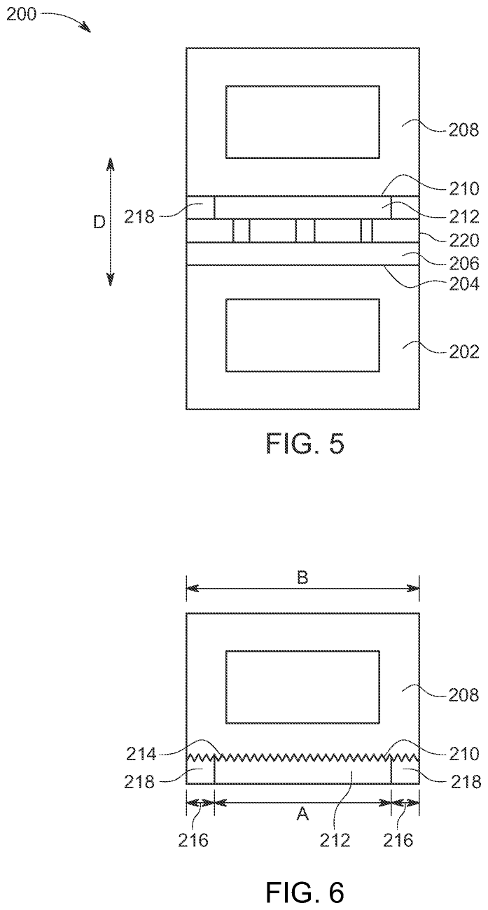

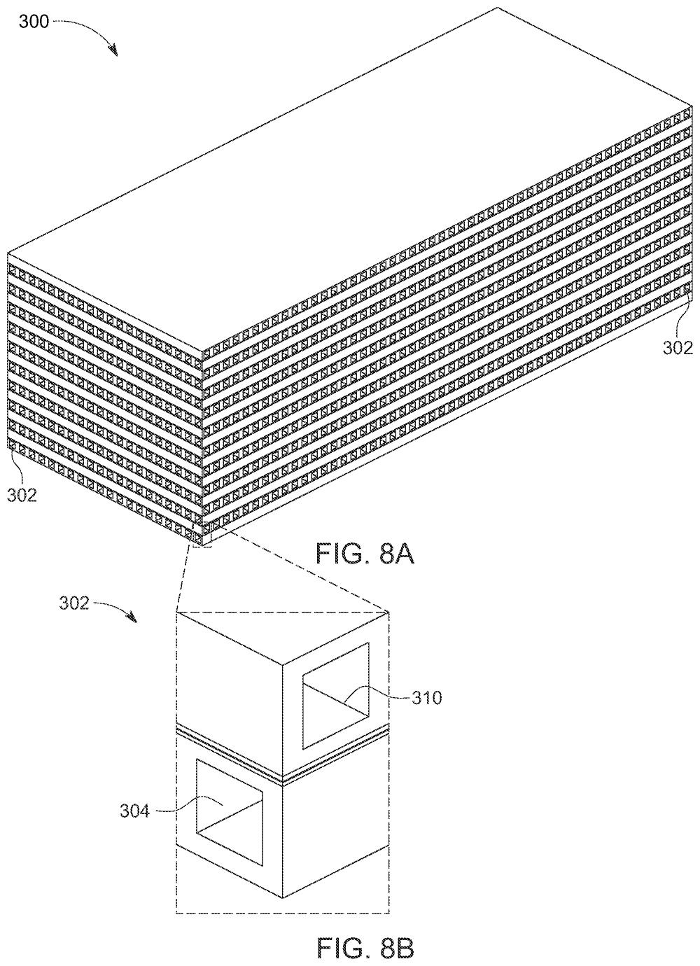

The improved manufacturing and durability of the PCFCs disclosed herein allow for the formation of units of multiple PCFCs for applications requiring greater power, such as vehicles and stationary power units. FIG. 8A is a schematic of an example of a unit 300 of multiple PCFCs 302 as disclosed herein. Any number of PCFCs can be used. FIG. 8B is an enlarged portion of the unit 300 of FIG. 8A, illustrating a PCFC 302 to better show the counterflow configuration of the fuel and cathode gas flow through the fuel flow channel 304 and the cathode gas flow channel 310, respectively. Alternatively, the multiple PCFCs 100, 200 can be arranged such that the fuel flow and the cathode gas flow are parallel, as illustrated in FIGS. 1-7.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A proton conduction fuel cell, comprising:
an anode support made of metal having a fuel flow channel;
an anode comprising an anode active material in contact with the anode support;
a cathode support made of metal having a cathode gas flow channel;
a cathode comprising a cathode active material in contact with the cathode support; and
an electrolyte layer comprising:
a first layer of electrolyte formed in a lock pattern on the anode; and
a second layer of the electrolyte formed in a key pattern on the cathode, the second layer fitting in the lock pattern of the first layer to form the electrolyte layer.

2. The proton conduction fuel cell of claim 1, wherein the lock pattern of the first layer is parallel first rows, each first row having a first width with a first space between adjacent first rows, the first space having a second width, and
the key pattern of the second layer is parallel second rows, each second row being the second width with a second space between adjacent second rows, the second space having the first width.

3. The proton conduction fuel cell of claim 2, wherein the first width is greater than the second width.

4. The proton conduction fuel cell of claim 1, wherein the lock pattern of the first layer has cutouts uniformly spaced across a surface area of the first layer, and
the key pattern of the second layer has islands of the electrolyte each formed in a shape of a cutout and uniformly positioned across a surface area of the second layer to align with the cutouts of the first layer.

5. The proton conduction fuel cell of claim 4, wherein a total surface area of the electrolyte in the first layer is greater than a total surface area of the electrolyte in the second layer.

6. The proton conduction fuel cell of claim 1, further comprising:
adhesive between the second layer of electrolyte and the cathode.

7. The proton conduction fuel cell of claim 6, wherein the adhesive is silicate glass.

8. The proton conduction fuel cell of claim 1, further comprising:
adhesive at an interface between the electrolyte of the first layer and the electrolyte of the second layer.

9. The proton conduction fuel cell of claim 1, wherein the electrolyte comprises one or more of BaCe_{0.4}Zr_{0.4}Y_{0.1}Yb_{0.1}O_{3-δ}, BaZr_{0.7}Ce_{0.2}Y_{0.1}O_{3-δ}, BaZr_{0.8}Y_{0.2}O_{3-δ}, BaZr_{0.9}Y_{0.1}O₃, BaCe_{0.9}Gd_{0.1}O₃, BaCe_{0.8}Zr_{0.1}Gd_{0.1}O₃, and BaCe_{0.65}Zr_{0.2}Y_{0.15}O_{3-δ}.

10. The proton conduction fuel cell of claim 1, wherein the anode active material is a BaCe_{0.4}Zr_{0.4}Y_{0.1}Yb_{0.1}O_{3-δ} and nickel composite.

11. The proton conduction fuel cell of claim 1, wherein the anode support has an anode facing surface and the cathode support has a cathode facing surface, wherein one or both of the anode facing surface and the cathode facing surface have surface irregularities.

12. The proton conduction fuel cell of claim 11, wherein:
the cathode facing surface has surface irregularities; and
the cathode has a smaller surface area perpendicular to a stacking direction than the cathode support and the electrolyte layer, defining a perimeter space around the cathode, the proton conduction fuel cell further comprising:
adhesive in the perimeter space.

13. The proton conduction fuel cell of claim 11, wherein:
the anode facing surface has surface irregularities in a form of a lock pattern; and
a support facing surface of the anode is modified to have a key pattern, the key pattern of the support facing surface fitting in the lock pattern of the anode facing surface of the anode support.

14. A proton conduction fuel cell, comprising:
an anode support made of metal;
an anode comprising an anode active material in contact with the anode support;
a cathode support made of metal;
a cathode comprising a cathode active material in contact with the cathode support; and
an electrolyte layer comprising:
a first layer of electrolyte formed in a lock pattern on the anode; and
a second layer of the electrolyte formed in a key pattern and attached to the cathode with an adhesive, the second layer fitting in the lock pattern of the first layer to form the electrolyte layer.

15. The proton conduction fuel cell of claim 14, wherein the adhesive is silicate glass and the electrolyte comprises BaCe_{0.4}Zr_{0.4}Y_{0.1}Yb_{0.1}O_{3-δ}or BaZr_{0.7}Ce_{0.2}Y_{0.1}O_{3-δ}.

16. The proton conduction fuel cell of claim 14, wherein the first layer has a total area of the electrolyte greater than a total area of the electrolyte of the second layer.

17. The proton conduction fuel cell of claim 14, further comprising:
adhesive between an area of contact between the electrolyte of the first layer and the electrolyte of the second layer.

18. The proton conduction fuel cell of claim 14, wherein the anode support has an anode facing surface and the cathode support has a cathode facing surface, wherein one or both of the anode facing surface and the cathode facing surface have surface irregularities.

19. The proton conduction fuel cell of claim 14, wherein:
the anode support has an anode facing surface having surface irregularities in a form of a lock pattern; and
a support facing surface of the anode is modified to have a key pattern, the key pattern of the support facing surface fitting in the lock pattern of the anode facing surface of the anode support.

20. The proton conduction fuel cell of claim 14, wherein the cathode has a smaller surface area perpendicular to a stacking direction than the cathode support and the electrolyte layer, defining a perimeter space around the cathode, the proton conduction fuel cell further comprising:
adhesive in the perimeter space.
